(19) United States
(12) Patent Application Publication
(10) Pub. No.: US 2009/0111912 A1
(43) Pub. Date: Apr. 30, 2009

(54) LOW TEMPERATURE, MOISTURE CURABLE COATING COMPOSITIONS AND RELATED METHODS

(75) Inventors: Anthony M. Chasser, Allison Park, PA (US); Susan F. Donaldson, Allison Park, PA (US); Terri L. Ziegler, Cranberry Township, PA (US); John R. Schneider, Glenshaw, PA (US)

Correspondence Address: PPG INDUSTRIES INC;INTELLECTUAL PROPERTY DEPT, ONE PPG PLACE, PITTSBURGH, PA, 15272, US

(73) Assignee: PPG Industries Ohio, Inc., Cleveland, OH (US)

(21) Appl. No.: 12/329,087

(22) Filed: Dec. 5, 2008

Related U.S. Application Data
(63) Continuation-in-part of application No. 11/839,155, filed on Aug. 15, 2007.
Application No. 11/839,155 is a continuation-in-part of application No. 11/839,165, filed on Aug. 15, 2007.
(60) Provisional application No. 60/826,431, filed on Sep. 21, 2006.
(60) Provisional application No. 60/826,431, filed on Sep. 21, 2006.

(51) Int. Cl. C09D 163/00; C09D 183/08

(52) U.S. Cl. 523/442; 524/588; 524/500; 524/432; 524/433; 524/431

(57) ABSTRACT

Disclosed are low temperature, moisture curable coating compositions, related coated substrates, and methods for coating a substrate. The coating compositions include an ungelled, secondary amine-containing Michael addition reaction product of reactants including a compound comprising more than one site of ethylenic unsaturation, and an aminofunctional silane.

### CROSS-REFERENCE TO RELATED APPLICATIONS

This application is a continuation-in-part of U.S. patent application Ser. Nos. 11/839,155 and 11/839,165, both filed Aug. 15, 2007, both of which claim the benefit of U.S. Provisional Patent Application Ser. No. 60/826,431, filed Sep. 21, 2006, each of which being incorporated herein by reference.

### FIELD OF THE INVENTION

The present invention relates to low temperature, moisture curable coating compositions, related coated substrates, and methods for depositing a coating on a substrate.

### BACKGROUND INFORMATION

Low temperature, moisture-curable coating compositions are desirable in many applications. For example, such coating compositions are, in at least some cases, preferable over, for example, thermally-cured or radiation cured coating compositions because (i) little or no energy is required to cure the composition, (ii) the materials from which some substrates are constructed cannot withstand elevated temperature cure conditions, and/or (iii) large or complex articles to be coated may not be convenient for processing through thermal or radiation cure equipment.

Some coating compositions are based on the hydrolysis and condensation of silane based materials that form a crosslinked Si—O—Si matrix. These compositions often form hard, highly crosslinked films, which are limited in flexibility. Therefore, the resultant coatings are often susceptible to chipping or thermal cracking due to embrittlement of the coating film. Moreover, such films can be especially unsuitable for use in coating substrates that can bend or flex, such as elastomeric automotive parts and accessories, for example, elastomeric bumpers and body side moldings, as well as consumer electronics equipment, among other things. The coating compositions applied to such elastomeric substrates typically must be very flexible so the coating can bend or flex with the substrate without cracking.

As a result, it would be desirable to provide low temperature, moisture curable coating compositions that are capable of producing a flexible, crack resistant coating when applied to a substrate and cured. Moreover, it would be desirable to provide such coating compositions that are, in at least some cases, substantially solvent free, sprayable at room temperature, and storage stable. In addition, it would be desirable to provide means for improving the corrosion resistance of such compositions such that the compositions are suitable for deposition directly upon a metal substrate to produce an aesthetically pleasing glossy coating that imparts corrosion resistance properties to the substrate.

### SUMMARY OF THE INVENTION

In certain respects, the present invention is directed to low temperature, moisture curable coating compositions comprising: (1) at least one of: (a) an ungelled, secondary amine-containing, Michael addition reaction product of reactants comprising, or, in some cases, consisting essentially of: (i) a compound comprising more than one site of ethylenic unsaturation that, in some cases, may have a particulate material dispersed therein, and (ii) an aminofunctional silane and/or a polyaminosilane, and (b) a secondary amine-containing, Michael addition reaction product of reactants comprising, or, in some cases, consisting essentially of: (i) a compound comprising one site of ethylenic unsaturation that, in some cases, may have a particulate material dispersed therein, and (ii) an aminofunctional silane and/or a polyaminosilane; (2) a compound comprising functional groups reactive with the secondary amine of (1)(a) and/or (1)(b); and (3) chemically modified particles having an average primary particle size of no more than 500 nanometers.

In other respects, the present invention is directed to low temperature, moisture curable coating compositions comprising: (1) at least one of: (a) an ungelled, secondary amine-containing, Michael addition reaction product of reactants comprising, or, in some cases, consisting essentially of: (i) a compound comprising more than one site of ethylenic unsaturation that, in some cases, may have a particulate material dispersed therein, and (ii) an aminofunctional silane and/or a polyaminosilane, and (b) a secondary amine-containing, Michael addition reaction product of reactants comprising, or, in some cases, consisting essentially of: (i) a compound comprising one site of ethylenic unsaturation that, in some cases, may have a particulate material dispersed therein, and (ii) an aminofunctional silane and/or a polyaminosilane; (2) a compound comprising functional groups reactive with the secondary amine of (1)(a) and/or (1)(b); and (3) inorganic oxide particles comprising one or more of zinc oxide (ZnO), magnesium oxide (MgO), cerium oxide (CeO₂), and molybdenum oxide (MoO₃).

The present invention is also related to, inter alia, substrates at least partially coated with such compositions and by methods for coating substrates with such compositions.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously mentioned, certain embodiments of the present invention are directed to low temperature, moisture curable coating compositions. As used herein, the term “low temperature, moisture curable” refers to coating compositions that, following application to a substrate, are capable of curing in the presence of ambient air, the air having a relative humidity of 10 to 100 percent, such as 25 to 80 percent, and a temperature in the range of −10 to 120° C., such as 5 to 80° C., in some cases 10 to 60° C. and, in yet other cases, 15 to 40° C. As used herein, the term “cure” refers to a coating wherein any crosslinkable components of the composition are at least partially crosslinked. In certain embodiments, the crosslink density of the crosslinkable components, i.e., the degree of crosslinking, ranges from 5% to 100%, such as 35% to 85%, or, in some cases, 50% to 85% of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer conducted under nitrogen.

As will also be appreciated by those skilled in the art, the degree of cure can be determined by testing the solvent resistance of a coating to double rubs of methyl ethyl ketone. The higher the number of double rubs with no damage to the coating, the greater the degree of cure. In this test, an index finger holding a double thickness of cheesecloth saturated with methyl ethyl ketone is held at a 45° angle to the coating surface. The rub is made with moderate pressure at a rate of 1 double rub per second. As used herein, when it is stated that a coating is “completely cured” it means that the coating is resistant to 100, in some cases 200, double rubs of methyl ethyl ketone according to the foregoing procedure, with no damage to the coating.

As previously indicated, certain of the low temperature, moisture curable coating compositions of the present invention comprise an ungelled, secondary amine-containing, Michael addition reaction product of reactants comprising a compound comprising more than one site of ethylenic unsaturation, i.e., a polyethylenically unsaturated compound, such as a poly(meth)acrylate. As used herein, the term “(meth)acrylate” is intended to include both methacrylates and acrylates. As used herein, the term “secondary amine-containing” refers to compounds comprising a secondary amine, which is a functional group wherein two organic substituents are bound to a nitrogen together with one hydrogen. As used herein, the term “ungelled” refers to resins that are substantially free of crosslinking and have an intrinsic viscosity when dissolved in a suitable solvent, as determined, for example, in accordance with ASTM-D1795 or ASTM-D4243. The intrinsic viscosity of the resin is an indication of its molecular weight. A gelled resin, on the other hand, since it is of essentially infinitely high molecular weight, will have an intrinsic viscosity too high to measure. As used herein, a resin (or polymer) that is “substantially free of crosslinking” refers to a reaction product that has a weight average molecular weight (Mw), as determined by gel permeation chromatography, of less than 1,000,000.

In certain embodiments, the compound comprising more than one site of ethylenic unsaturation comprises a polyethylenically unsaturated monomer, such as di- and higher acrylates. Specific examples of suitable polyethylenically unsaturated monomers are diacrylates, such as 1,6-hexanediol diacrylate (“HDDA”), 1,4-butanediol diacrylate, ethylene glycol diacrylate, diethylene glycol diacrylate, tetraethylene glycol diacrylate, tripropylene glycol diacrylate (“TPGDA”), neopentyl glycol diacrylate, 1,4-butanediol dimethacrylate, poly(butanediol) diacrylate, tetraethylene glycol dimethacrylate, 1,3-butylene glycol diacrylate, triethylene glycol diacrylate, triisopropylene glycol diacrylate, polyethylene glycol diacrylate, and/or bisphenol A dimethacrylate; triacrylates, such as trimethylolpropane triacrylate (“TMPTA”), trimethylolpropane trimethacrylate, pentaerythritol monohydroxy triacrylate, and/or trimethylolpropane triethoxy triacrylate; tetraacrylates, such as pentaerythritol tetraacrylate, and/or di-trimethylolpropane tetraacrylate; and/or pentaacrylates, such as dipentaerythritol (monohydroxy) pentaacrylate.

In addition to or in lieu of the aforementioned polyethylenically unsaturated monomers, the ambient curable compositions of the present invention may comprise the Michael addition reaction product of reactants comprising a polyethylenically unsaturated oligomer. As will be appreciated, the term “oligomer” and “polymer” are frequently used interchangeably. Although the term “oligomer” is generally used to describe a relatively short polymer, the term has no generally accepted definition with respect to the number of repeating monomer units. As used herein, therefore, in describing compounds comprising more than one site of ethylenic unsaturation, the terms “oligomer” and “polymer” are meant to be interchangeable.

Examples of some specific polyethylenically unsaturated oligomers suitable for use in the present invention include, for example, urethane acrylates, polyester acrylates and mixtures thereof, particularly those that are free of hydroxyl functional groups. Specific examples of such materials include urethane acrylates, such as Ebecryl 220 and Ebecryl 264 available from Cytec Surface Specialties Inc. and polyester acrylates, such as Ebecryl 80 available from UCB Chemicals.

In certain embodiments of the present invention, at least some of the compound comprising more than one site of ethylenic unsaturation that participates in the Michael addition reaction with an aminofunctional silane and/or, as described below, a polyaminosilane, has a particulate material, i.e., a plurality of particles, dispersed therein that can, in at least some cases, act to decrease the cure time of the coating compositions of the present invention.

As a result, certain coating compositions of the present invention comprise an ungelled, secondary amine-containing, Michael addition reaction product of reactants comprising, or, in some cases, consisting essentially of: (a) a compound comprising more than one site of ethylenic unsaturation that has a particulate material dispersed therein; and (b) an aminofunctional silane and/or a polyaminosilane.

In certain embodiments, the particulate material has an average particle size less than 50 microns, such as 1 to less than 1000 nanometers, 1 to less than 300 nanometers, or, in some cases 1 to less than 100 nanometers, in yet other cases, 5 to 50 or 5 to 25 nanometers, prior to incorporation into the composition.

In certain embodiments where the average particle size of the particles is greater than one micron, the average particle size can be measured according to known laser scattering techniques. For example, the average particle size of such particles can be measured using a Horiba Model LA 900 laser diffraction particle size instrument, which uses a helium-neon laser with a wave length of 633 nm to measure the size of the particles and assumes the particle has a spherical shape, i.e., the “particle size” refers to the smallest sphere that will completely enclose the particle.

In embodiments of the present invention wherein the size of the particles is less than or equal to one micron, the average particle size can be determined by visually examining an electron micrograph of a transmission electron microscopy (“TEM”) image, measuring the diameter of the particles in the image, and calculating the average particle size based on the magnification of the TEM image. For example, a TEM image with 105,000× magnification can be produced, and a conversion factor is obtained by dividing the magnification by 1000. Upon visual inspection, the diameter of the particles is measured in millimeters, and the measurement is converted to nanometers using the conversion factor. The diameter of the particle refers to the smallest diameter sphere that will completely enclose the particle.

The shape (or morphology) of the particles can vary. For example generally spherical morphologies (such as solid beads, microbeads, or hollow spheres), can be used, as well as particles that are cubic, platy, or acicular (elongated or fibrous). Additionally, the particles can have an internal structure that is hollow, porous or void free, or a combination of any of the foregoing, e.g., a hollow center with porous or solid walls.

Mixtures of one or more particles having different compositions, average particle sizes and/or morphologies can be incorporated into the compositions of the present invention to impart the desired properties and characteristics to the compositions.

Suitable particles include, for example, those described in U.S. Pat. No. 7,053,149 at col. 19, line 5 to col. 23, line 39, the cited portion of which being incorporated herein by reference.

In certain embodiments of the present invention, the polysiloxane described below is nonreactive with the particles.

In certain embodiments, the compound comprising more than one site of ethylenic unsaturation that has a particulate material dispersed therein, which is present in certain embodiments of the coating compositions of the present invention, comprises a silica sol comprising silica nanoparticles and a polymerizable (meth)acrylate binding agent. As used herein, the term “silica sol” refers to a colloidal dispersion of finely divided silica particles dispersed in a binding agent, which, in certain embodiments of the present invention, comprises a compound comprising more than one site of ethylenic unsaturation. As used herein, the term “silica” refers to SiO₂. As used herein, the term “nanoparticles” refers to particles that have an average primary particle size of less than 1 micron. In certain embodiments, the nanoparticles have an average primary particle size of 300 nanometers or less, such as 200 nanometers or less, or, in some cases, 100 nanometers or less, or, in yet other cases, 50 nanometers or less, or, in some cases, 20 nanometers or less. As used herein, the term “primary particle size” refers to the size of an individual particle, as opposed to an agglomeration of particles.

As indicated, in certain embodiments, the silica sol comprises a binding agent that is a compound comprising more than one site of ethylenic unsaturation, such as any of the exemplary materials described earlier. Silica sols of this type that are suitable for use in the present invention are commercially available. Examples include the Nanocryl® line of products, such as Nanocryl C140 (binding agent is HDDA), Nanocryl C145 (binding agent is TPGDA), and Nanocryl C150 (binding agent is TMPTA), available from Hanse Chemie AG, Geesthacht, Germany, as well as the HIGHLINK® products available from Clariant Int'l Ltd., such as HIGHLINK NanO G 103-31. These products are low viscosity sols having a silica content of up to 50 percent by weight.

As previously indicated, in certain embodiments of the coating compositions of the present invention, the compound(s) comprising more than one site of ethylenic unsaturation identified above is reacted with an aminofunctional silane. As used herein, the term “aminofunctional silane” refers to a compound having a molecular structure that includes an amine group, including, but not limited to, blocked amines or derivatives thereof, and a silicon atom.

In certain embodiments, the aminofunctional silane utilized in the coating compositions of the present invention comprises a compound having the formula:

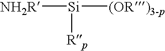

wherein R′ is an alkylene group having from 2 to 10 carbon atoms, R″ is an alkyl, aryl, alkoxy, or aryloxy group having from 1 to 8 carbon atoms, R′″ is an alkyl group having from 1 to 8 carbon atoms, and p has a value of from 0 to 2. In certain embodiments of the present invention, R′ is an alkylene group having from 2 to 5 carbon atoms and p is 0, the use of which the inventors have discovered is, in at least some embodiments, best for obtaining dust free films in 10 minutes or less and completely cured films within 24 hours, under the low temperature, moisture cure conditions described earlier.

Specific examples of aminofunctional silanes which are suitable for use in the present invention include aminoethyltriethoxysilane, γ-aminopropyltriethoxysilane, γ-aminopropylmethyldiethoxysilane, γ-aminopropylethyldiethoxysilane, γ-aminopropylphenyldiethoxysilane, γ-aminopropyltrimethoxysilane, δ-aminobutyltriethoxysilane, δ-aminobutylethyldiethoxysilane. In certain embodiments, the aminofunctional silane comprises a γ-aminopropyltrialkoxysilane.

In certain embodiments of the present invention, little or no other reactant, such as a polyamine, is added to the reactant mixture for the Michael addition reaction. As a result, in certain embodiments, the reactants taking part in the Michael addition reaction are substantially free, or, in some cases, completely free of any polyamine. As used herein, the term “polyamine” refers to compounds comprising two or more primary or secondary amino groups. As used herein, the term “substantially free” means that the material being discussed is present in a composition, if at all, as an incidental impurity. In other words, the material does not affect the properties of the composition. As used herein, the term “completely free” means that the material being discussed is not present in a composition at all. The inventors have discovered that the presence of any significant quantity of polyamine can, in at least some cases, result in increased yellowing, the generation of additional unwanted byproducts, and/or an undesirable accelerated building of viscosity in the Michael addition reaction product.

In certain embodiments, the ungelled Michael addition reaction product is formed by simply blending the reactants at room temperature or at a slightly elevated temperature, for example, up to 100° C. The reaction of an amine group with an ethylenically unsaturated group which occurs in this invention is often referred to as a Michael addition reaction. As a result, as used herein, the term “Michael addition reaction product” is meant to refer to the product of such a reaction. Such products can be more heat and light stable than greater acrylyl content-containing products. It should be recognized that slowly adding the aminofunctional silane to the compound comprising more than one site of ethylenic unsaturation results in there being a large excess of acrylate groups to aminofunctional silane. Unless the temperature of the reaction mixture is kept sufficiently low, a gelled product can be the result. It is sometimes better, therefore, to add the unsaturated material to a reaction vessel already containing an aminofunctional silane to obtain an ungelled reaction product. The reaction can be carried out in the absence of a solvent or in the presence of an inert solvent. Examples of suitable inert solvents are toluene, butyl acetate, methyl isobutyl ketone, and ethylene glycol monoethyl ether acetate. It is often desirable that the reaction be conducted in the absence of moisture or in a controlled amount of moisture to avoid unwanted side reactions and possibly gelation.

In certain embodiments, Michael addition reaction described above is conducted such that the equivalent ratio of the ethylenically unsaturated groups to the amine groups is at least 1:1, in some cases, at least 1.05:1.

In certain embodiments, the Michael addition reaction product identified above is present in the coating compositions of the present invention in an amount of at least 30 percent by weight, such as at least 40 percent by weight, based on the total weight of the composition. In certain embodiments, the Michael addition reaction product identified above is present in the coating compositions of the present invention in an amount of no more than 80 percent by weight, such as no more than 60 percent by weight, with the weight percents being based on the total weight of the composition.

In certain embodiments, the coating compositions of the present invention comprise a Michael addition reaction product of reactants comprising, or, in some cases, consisting essentially of: (a) a compound comprising one site of ethylenic unsaturation, and (b) an aminofunctional silane. In some embodiments, the compound comprising one site of ethylenic unsaturation has a particulate material dispersed therein.

In certain embodiments, the compound comprising one site of ethylenic unsaturation comprises a (meth)acrylate, including, for example, any C₁-C₃₀ aliphatic alkyl ester of (meth)acrylic acid, non-limiting examples of which include methyl(meth)acrylate, ethyl(meth)acrylate, propyl(meth)acrylate, N-butyl(meth)acrylate, t-butyl(meth)acrylate, 2-ethylhexyl(meth)acrylate, isobornyl (meth)acrylate, glycidyl (meth)acrylate, dimethylaminoethyl (meth)acrylate, N-butoxy methyl(meth)acrylamide, lauryl (meth)acrylate, cyclohexyl (meth)acrylate, and 3,3,5-trimethylcyclohexyl (meth)acrylate.

Suitable aminofunctional silanes for reaction with the compound(s) comprising one site of ethylenic unsaturation include any of the aminofunctional silanes previously identified herein.

In certain embodiments of the present invention, little or no other reactant, such as a polyamine, is added to the reactant mixture for the foregoing Michael addition reaction between the compound comprising one site of ethylenic unsaturation and the aminofunctional silane. As a result, in certain embodiments, the reactants taking part in such a Michael addition reaction are substantially free, or, in some cases, completely free of any polyamine.

In certain embodiments, the Michael addition reaction between the compound comprising one site of ethylenic unsaturation, and the aminofunctional silane is performed by simply blending the reactants at room temperature or at a slightly elevated temperature, for example, up to 100° C. The reaction can be carried out in the absence of a solvent or in the presence of an inert solvent. Examples of suitable inert solvents include any of the solvents previously identified herein.

In certain embodiments, Michael addition reaction between the compound comprising one site of ethylenic unsaturation and the aminofunctional silane is conducted such that the equivalent ratio of the ethylenically unsaturated groups to the amine groups is at least 1:1, in some cases, at least 1.05:1.

In certain embodiments, the Michael addition reaction product of the reaction between an aminofunctional silane and a compound comprising one site of ethylenic unsaturation identified above is present in the coating compositions of the present invention in an amount of up to 30 percent by weight, such as up to 25 percent by weight, based on the total weight of the composition. In certain embodiments, the Michael addition reaction product of the reaction between an aminofunctional silane and a compound comprising one site of ethylenic unsaturation identified above is present in the coating compositions of the present invention in an amount of at least 10 percent by weight, such as at least 15 percent by weight, based on the total weight of the composition.

In certain embodiments, the coating compositions of the present invention comprise a polyaminosilane. As used herein, the term “polyaminosilane” refers to a compound having a molecular structure that includes more than one amine group, including, but not limited to, blocked amines or derivatives thereof, and a silicon atom.

In certain embodiments, the polyaminosilane identified above that is utilized in the coating compositions of the present invention comprises a compound having the formula:

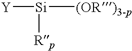

wherein Y═H(HNR)_{c}, wherein R is an alkylene group having from 2 to 10 carbon atoms and c is ≧2; R″ is an alkyl, aryl, alkoxy, or aryloxy group having from 1 to 8 carbon atoms, R′″ is an alkyl group having from 1 to 8 carbon atoms, and 0≦p≦2. In certain embodiments of the present invention, p is 0 or 1, in some cases 1.

Specific examples of such polyaminosilanes, which are suitable for use in the present invention, are N(beta-aminoethyl) γ-aminopropyltrimethoxysilane, which is represented by the chemical formula H₂NCH₂CH₂NHCH₂CH₂CH₂Si(OCH₃)₃, and N(beta-aminoethyl) γ-aminopropymethyldimethoxysilane, which is represented by the chemical formula H₂NCH₂CH₂NHCH₂CH₂CH₃Si(OCH₃)₂, both of which are commercially available from, for example, Momentive Performance Chemicals, under the tradenames SILQUEST® A-1120 and SILQUEST® A-2120, respectively.

In certain embodiments, the polyaminosilane is present in the coating compositions of the present invention in an amount of up to 20 percent by weight, in some cases up to 10 percent by weight, based on the total weight of the composition. In certain embodiments, the polyaminosilane is present in the coating compositions of the present invention in an amount of at least 1 percent by weight, such as at least 2 percent by weight, based on the total weight of the composition.

In certain embodiments, the coating compositions of the present invention comprise the ungelled, secondary amine-containing, Michael addition reaction product of reactants comprising or, in some cases, consisting essentially of: (a) a compound comprising one or more than one site of ethylenic unsaturation, i.e., a polyethylenically unsaturated compound, such as the poly(meth)acrylates and polyethylenically unsaturated oligomers described earlier, and/or the (meth)acrylates described earlier which, in certain embodiments, have a particulate material dispersed therein, and (b) a polyaminosilane, such as is described above.

In certain embodiments, the ungelled Michael addition reaction product formed from the compound comprising more than one site of ethylenic unsaturation and the polyaminosilane is formed by simply blending the reactants at room temperature or at a slightly elevated temperature, for example, up to 100° C. It should be recognized that slowly adding the polyaminosilane to the compound comprising more than one site of ethylenic unsaturation results in there being a large excess of acrylate groups to polyaminosilane. Unless the temperature of the reaction mixture is kept sufficiently low, a gelled product can be the result. It is sometimes better, therefore, to add the unsaturated material to a reaction vessel already containing the polyaminosilane to obtain an ungelled reaction product. The reaction can be carried out in the absence of a solvent or in the presence of an inert solvent. Examples of suitable inert solvents are toluene, butyl acetate, methyl isobutyl ketone, and ethylene glycol monoethyl ether acetate. It is often desirable that the reaction be conducted in the absence of moisture or in a controlled amount of moisture to avoid unwanted side reactions and possibly gelation.

In certain embodiments, the ungelled, Michael addition reaction product of the compound comprising one or more sites of ethylenic unsaturation and the polyaminosilane is present in the coating compositions of the present invention in an amount of up to 30 percent by weight, in some cases up to 25 percent by weight, based on the total weight of the composition. In certain embodiments, the foregoing reaction product is present in the coating compositions of the present invention in an amount of at least 10 percent by weight, such as at least 15 percent by weight, based on the total weight of the composition.

As previously indicated, to produce the coating compositions of the present invention, the previously described Michael addition reaction product(s) are combined with a compound comprising functional groups reactive with the secondary amines present in the Michael addition reaction product(s). As will be appreciated by those skilled in the art, such functional groups include, but are not limited to, isocyanates, epoxies, and ethylenically unsaturated groups. In certain embodiments, such a compound is selected from a polyepoxide, a compound having two or more ethylenically unsaturated groups, or a mixture thereof.

As used herein, the term “polyepoxide” refers to an epoxy resin having at least two 1,2-epoxide groups per molecule. In certain embodiments, the epoxy equivalent weight ranges from 100 to 4000 based on solids of the polyepoxide, such as between 100 and 1000. The polyepoxides may be, for example, saturated or unsaturated, and may be, for example, aliphatic, alicyclic, aromatic, or heterocyclic. They may contain substituents such as, for example, halogens, hydroxyl groups, and ether groups.

Suitable classes of polyepoxides include epoxy ethers obtained by reacting an epihalohydrin, such as epichlorohydrin, with a polyphenol in the presence of an alkali. Suitable polyphenols include, for example, resorcinol, catechol, hydroquinone, bis(4-hydroxyphenyl)-2,2-propane (Bisphenol A), bis(4-hydroxyphenyl)-1,1-isobutane, bis(4-hydroxyphenyl)-1,1-ethane, bis(2-hydroxyphenyl)-methane, 4,4-dihydroxybenzophenone, and 1,5-dihydroxynaphthalene. In some cases, the diglycidyl ether of Bisphenol A is especially suitable.

Other suitable polyepoxides include polyglycidyl ethers of polyhydric alcohols and/or polyhydric silicones. Suitable polyhydric alcohols include, without limitation, ethylene glycol, propylene glycol, butylene glycol, 1,6-hexylene glycol, neopentyl glycol, diethylene glycol, glycerol, trimethylol propane, and pentaerythritol. These compounds may also be derived from polymeric polyols, such as polypropylene glycol.

Examples of other suitable polyepoxides include polyglycidyl esters of polycarboxylic acids. These compounds may be formed by reacting epichlorohydrin or another epoxy material with an aliphatic or aromatic polycarboxylic acid, such as succinic acid, adipic acid, azelaic acid, sebacic acid, maleic acid, 2,6-naphthalene dicarboxylic acid, fumaric acid, phthalic acid, tetrahydrophthalic acid, hexahydrophthalic acid, or trimellitic acid. Dimerized unsaturated fatty acids containing about 36 carbon atoms (Dimer Acid) and polymeric polycarboxylic acids, such as carboxyl terminated acrylonitrile-butadiene rubber, may also be used in the formation of these polyglycidyl esters of polycarboxylic acids.

Polyepoxides derived from the epoxidation of an olefinically unsaturated alicyclic compound are also suitable for use in the coating compositions of the present invention. These polyepoxides are nonphenolic and are obtained by epoxidation of alicyclic olefins with, for example, oxygen, perbenzoic acid, acid-aldehyde monoperacetate, or peracetic acid. Such polyepoxides include the epoxy alicyclic ethers and esters well known in the art.

Other suitable polyepoxides include epoxy novolac resins. These resins are obtained by reacting an epihalohydrin with the condensation product of aldehyde and monohydric or polyhydric phenols. A typical example is the reaction product of epichlorohydrin with a phenol-formaldehyde condensate.

Suitable polyepoxides also include epoxy-functional organopolysiloxanes, such as the resins described in U.S. Pat. No. 6,344,520 at col. 3, line 46 to col. 6, line 41, the cited portion of which being incorporated herein by reference.

The coating compositions of the present invention may contain one polyepoxide or a mixture of two or more polyepoxides.

As indicated, in certain embodiments, the compound comprising functional groups reactive with secondary amines of the Michael addition reaction product(s) comprises a compound having two or more ethylenically unsaturated groups. Suitable materials include the polyethylenically unsaturated monomers, such as the di- and higher acrylates described earlier.

In certain embodiments, however, such a compound comprises an oligomer containing polymerizable ethylenic unsaturation. Examples of such oligomers, which are suitable for use in the present invention, include polyurethane acrylates, polyester acrylates, polyether acrylates, polyacrylates derived from polyepoxides, and acrylate functional acrylic polymers. As will be appreciated by those skilled in the art, such oligomers can be prepared from polyurethane polyols, polyester polyols, polyether polyols, polybutadiene polyols, acrylic polyols, and epoxide resins by reacting all or portions of the hydroxyl groups or epoxy groups with acrylic or methacrylic acid. Also, polyols such as pentaerythritol and trimethylol 10 propane, propylene glycol, and ethylene glycol can be used. Acrylate functional compounds can also be obtained by transesterifying polyols with lower alcohol esters of (meth)acrylic acid.

In certain embodiments of the present invention, the compound comprising functional groups reactive with secondary amines of the Michael addition reaction product(s) comprises a tetrafunctional polyester acrylate, such as that which is commercially available from Sartomer under the tradename CN 2262.

The coating compositions of the present invention may contain one compound having two or more ethylenically unsaturated groups or a mixture of two or more compounds having two or more ethylenically unsaturated groups.

In certain embodiments, the compound comprising functional groups reactive with secondary amines of the Michael addition reaction product comprises an epoxysilane. As used herein, the term “epoxysilane” refers to a compound having a molecular structure that includes more than one oxirane rings and a silicon atom.

In certain embodiments, the epoxysilane identified above that is utilized in the coating compositions of the present invention comprises a compound having the general formula:

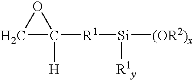

having one or more oxirane rings, wherein R₁ is a hydrocarbon having from one to six carbon atoms, R₂ is a hydrocarbon having from one to three carbon atoms, where each R₂ can be the same or different, and where x is equal to two or three; and y is 0 when x is 3 and y is 1 when x is 2. In certain embodiments, R₁ is an oxyalkyl group and the R₂ groups are methyl groups.

Specific examples of such epoxysilanes, which are suitable for use in the present invention, are γ-glycidoxyproyltrimethoxysilane and β-(3,4-epoxycyclohexyl)ethyltrimethoxysilane, that are commercially available from Momentive Performance Chemicals, under the tradenames SILQUEST® A-187 and SILQUEST® A-186, respectively. The coating compositions of the present invention may contain one epoxysilane or a mixture of two or more epoxysilanes.

In certain embodiments of the present invention, the compound(s) comprising functional groups reactive with the secondary amines of the Michael addition reaction product(s) is present in the composition in an amount such that the molar ratio of secondary amines to the functional groups reactive therewith is 0.7 to 1.3, in some cases, 0.9 to 1.1, and, in yet other cases 1:1. Indeed, the present inventors have surprisingly discovered that in certain embodiments of the present invention wherein the aforementioned molar ratio is within such a range, the coating compositions are resistant to cracking after exposure to various environmental conditions, such as those described in the Examples, when applied so as to result in a dry film thickness of up to 20 mils, such as 1 to 20 mils. As used herein, the term “resistant to cracking” means that the completely cured coating exhibits no cracks visible to the naked eye at any distance.

As previously indicated, certain embodiments of the coating compositions of the present invention comprise a titanate and/or a partial hydrolysate thereof. Indeed, it was surprisingly discovered that the addition of such a material to certain embodiments of the coating compositions of the present invention not only resulted in coating compositions capable of producing flexible coatings with reduced dry times, but also produced coatings with significantly improved corrosion resistance properties when the coating was applied directly to a bare or pretreated metal substrate, such as a phosphated iron-based metal, such as steel, relative to a similar composition without the titanate.

As used herein, the term “titanate” refers to a compound comprising four alkoxy groups, which compound is represented by the formula Ti(OR)₄, wherein each R is individually a hydrocarbyl radical containing from, for example, 1 to 10, such as 1 to 8, or, in some cases 2 to 5 carbon atoms per radical, such as, for example, alkyl radicals, cycloalkyl radicals, alkylenyl radicals, aryl radicals, alkaryl radicals, aralkyl radicals, or combinations of two or more thereof, i.e., each R can be the same or different. Such materials are described, for example, in U.S. Pat. No. 6,562,990 at col. 4, line 63 to col. 5, line 9, the cited portion of which being incorporated herein by reference. Commercially available materials, which are examples of such titanates, are the products sold by DuPont under the tradename TYZOR®, such as TYZOR TPT, which refers to tetraisopropyl titanate, TYZOR TnBT, which refers to tetra-n-butyl titanate, and TYZOR TOT, and which refers to tetra-2-ethylhexyl titanate.

In certain embodiments, the titanate used in the coating compositions of the present invention is chelated, such as, for example, titanium acetylacetonates and triethanolamine titanates. Exemplary chelated titanates include, for example, compounds having the formulas T1 through T24 as listed in United States Patent Application Publication No. 2006/0263708 paragraph [0029], the cited portion of which being incorporated herein by reference.

Suitable chelated titanates include, but are not limited to, products commercially available from DuPont under the TYZOR tradename, such as TYZOR AA-105. Suitable chelated titanates also include, but are not limited to, the chelated titanates described in U.S. Pat. Nos. 2,680,108 and 6,562,990, which are incorporated herein by reference. In certain embodiments of the present invention, a chelated titanate is used that is formed from the use of a chelating agent comprising a dicarbonyl compound. Dicarbonyl compounds that are suitable for use in preparing the titanium chelate utilized in certain embodiments of the coating compositions of the present invention include, but are not limited to, the materials described in U.S. Pat. No. 2,680,108 at col. 2, lines 13-16 and U.S. Pat. No. 6,562,990 at col. 2, lines 56-64.

In certain embodiments, the titanate is present in the coating compositions of the present invention in an amount of up to 20 percent by weight, in some cases up to 10 percent by weight, based on the total weight of the composition. In certain embodiments, the titanate is present in the coating compositions of the present invention in an amount of at least 0.1 percent by weight, such as at least 1 percent by weight, based on the total weight of the composition.

In addition to the foregoing, certain embodiments of the coating compositions of the present invention comprise additional additives that may act to, for example, improve the corrosion resistance of coatings formed from the coating compositions of the present invention. For example, in certain embodiments, such additives may comprise one or more of the “corrosion resisting particles” described in United States Patent Application Publication No. 2008-0022886A1 at [0020] to [0083] and [0108] to [0109], the cited portions of which being incorporated herein by reference.

Certain of the foregoing corrosion resisting particles have been surprisingly discovered to be particularly useful in certain embodiments of the coating compositions of the present invention, particularly in cases where the coating composition is intended for use as a monocoat over a bare or pretreated metal substrate. In particular, it has been surprisingly discovered that corrosion resisting particles comprising chemically modified particles having an average primary particle size of no more than 500 nanometers, in some cases, no more than 200 nanometers, and, in yet other cases, no more than 100 nanometers, such as are described in U.S. Pat. No. 6,790,904 at col. 3, line 43 to col. 8, line 46; United States Patent Application Publication No. 2003/0229157 A1 at [0021] to [0048]; U.S. Pat. No. 6,835,458 at col. 4, line 54 to col. 7, line 58; and U.S. Pat. No. 6,593,417 at col. 23, line 48 to col. 24, line 32, the cited portions of which being incorporated by reference herein, can, in at least some cases, substantially improve the corrosion resisting properties of coatings deposited from the coating compositions of the present invention without detrimentally effecting the gloss, color, and/or appearance of the resultant coating.

In certain embodiments, such chemically modified particles include particles that have been reacted with a compound having a surface active moiety. “Surface active” as used herein refers to any compound or moiety that, when attached to the particles, lowers the solid surface tension or surface energy of the particle.

For modification to be affected, the particles need an active site or functional group. The surface-active moiety must be able to chemically attach to the surface of the particles by reacting with one or more of these active sites or functional groups. Particles that do not have an active site can be given one by reacting the particles with water. In the reaction with water, the Si—O—Si bonds on the particle surface break (in the case of silica particles) and form two Si—OH groups.

Suitable compounds having a surface-active moiety can have the general structure F-L-Z wherein F is a moiety containing one or more functional groups that will react with the particle surface, Z is a surface active moiety that decreases the surface tension of the particle, and L is a group that links F and Z.

Examples of compounds within general structure (II) that can be reacted with the present particles can be represented by structure Si(OR₁₂)₃—(CH₂)ₙ₁-Z wherein R₁₂ is an alkyl moiety having 1 to 30 carbons, such as 1 or 2 carbons, Z is, as described above, a moiety that decreases the surface tension of the particle to which it is attached and n1 is 0 to 5.

The Z moiety can have no functional groups, or it can have one or more functional groups, such as two or more functional groups. The functional groups, if present, can be selected, for example, based on their ability to react with the crosslinker used in the resin formation. For certain applications, such reaction may be undesirable and the Z moiety does not contain any functional or reactive group.

Any Z moiety can be used according to the present invention, and will generally fall into one of three categories: a long chain alkyl group; a fluorocarbon-containing material; and a silane to which is attached at least two methyl groups. “Long chain” as used in this context refers to four or more carbon atoms, and a fluorocarbon-containing material refers to a material comprising at least one CF₃ group. The long chain alkyl group can be linear or branched. The Z moiety can be introduced to the particle in any manner known in the art. For example, the Z moiety may be part of a compound that, by itself, reacts with the particle, (i.e. contains an F moiety) such as a compound that contains a trialkoxy silane.

Alternatively, a compound containing a Z moiety can be reacted with another compound that contains an F moiety. This can be done by any means known in the art, by selecting the appropriate L moiety to bring together the F and Z moieties. For example, a trialkoxy silane wherein the fourth substituent has a first functional group can be reacted with a compound containing both a “Z” moiety and a second functional group; the first and second functional groups are selected so as to be reactive with each other. Upon reaction, the F and Z moieties are linked. Any pair of functional groups can be used. For example, if one functional group is an epoxy, the other can be an amine, a carboxylic acid or a hydroxy; if one functional group is an amine, the other can be an epoxy, isocyanate or carboxylic acid; if one functional group is an isocyanate, the other can be an amine or hydroxy; and if one functional group is an acrylate, the other can be an amine. Specific examples include the reaction of glycidyloxytrimethoxy propylsilane (“A-187”) with a (di)alkylamine or A-187 with stearoyl sarcosine.

Examples of compounds having long alkyl chains are those within structure (III), wherein Z is —(CH₂)ₙ₂—CH₃, and n2 is 1 to 30, such as 7 to 17. In this embodiment, the total of n1 and n2 is three or greater. Specific examples include octyltrimethoxy silane, octyltriethoxy silane, and octadecyltriethoxy silane. In another particular embodiment within structure (III) that introduces a long alkyl chain, Z is ##STR2##

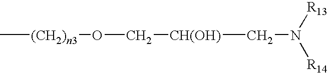

n3 is 1 to 3 and R₁₃ and R₁₄ are the same or different and R₁₃ can be hydrogen or an alkyl group having 1 to 30 carbons and R₁₄ is an alkyl group having 4 to 30 carbons. For example, R₁₃ can be H and R₁₄ can be C₆H₁₃, C₈H₁₇ or C₁₂H₂₅, or both R₁₃ and R₁₄ can be (C₄H₉). It will be appreciated that this embodiment also introduces functional groups into the “F-L-Z” compound.

Suitable chemically modified particles are also commercially available, such as those available under the tradename NANOBYK-3650, from Byk-Chemie.

Other suitable corrosion resisting particles are those that comprise an inorganic oxide, in some embodiments a plurality of inorganic oxides, such as, for example, zinc oxide (ZnO), magnesium oxide (MgO), cerium oxide (CeO₂), molybdenum oxide (MoO₃), and/or silicon dioxide (SiO₂), among others, such as those described in detail in United States Patent Application Publication No. 2008-0022886A1 at [0021] to [0039].

In certain embodiments, one or more of the “corrosion resisting particles” are present in the coating compositions of the present invention in an amount of 3 to 50 percent by volume, such as 8 to 30 percent by volume, or, in some cases, 10 to 18 percent by volume, wherein the volume percents are based on the total volume of the coating composition.

In certain embodiments, the coating compositions of the present invention also comprise a polysiloxane. Suitable polysiloxanes include those of the formula:

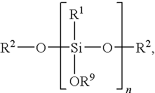

wherein each R¹ is independently selected from the group comprising alkyl and aryl radicals, R² and R⁹ which may be identical or different, are selected each independently from the group comprising hydrogen, alkyl and aryl radicals, n is selected so that the molecular weight for the polysiloxane is in the range of from 400 to 10,000.

Suitable polysiloxanes include, but are not necessarily limited to, those having a molecular weight ranging from 500 to 6000 and an alkoxy content ranging from 10 to 50%.

Examples of suitable polysiloxanes include, but are not limited to, the alkoxy- and silanol-functional polysiloxanes known to those skilled in the art. Suitable alkoxy-functional polysiloxanes include, but are not limited to: DC-3074 and DC3037 from Dow Corning; Silres SY-550, and SY-231 from Wacker Silicone; and Rhodorsil Resin 10369 A, Rhodorsil 48V750, 48V3500 from Rhodia Silicones; and SF1147 from General Electrics. Suitable silanol-functional polysiloxanes include, but are not limited to, Silres SY 300, Silres SY 440, Silres MK and REN 168 from Wacker Silicone, Dow Corning's DC-840, DC233 and DC-431 HS silicone resins and DC-Z-6018 intermediate and Rhodia Silicones' Rhodorsil Resin 6407 and 6482 X.

In certain embodiments, the previously described polysiloxane is present in the coating compositions of the present invention in an amount of up to 40 percent by weight, such as up to 30 percent by weight, based on the total weight of the composition. In certain embodiments, the previously described polysiloxane is present in the coating compositions of the present invention in an amount of at least 5 percent by weight, such as at least 10 percent by weight, based on the total weight of the composition.

The coating compositions of the present invention may also include a cure promoting catalyst, such as a base catalyst. Suitable base catalysts include triphenylphosphine, ethyltriphenyl phosphonium iodide, tetrabutyl phosphonium iodide and tertiary amines, such as benzyldimethylamine, dimethylaminocyclohexane, triethylamine, and the like, N-methylimidazole, and tetrabutyl ammonium hydroxide.

Other examples of suitable catalysts include nitrate of a polyvalent metal ion such as calcium nitrate, cerium nitrate, including ammonium cerium nitrate, magnesium nitrate, aluminum nitrate, zinc nitrate, or strontium nitrate. When used, such catalysts are, in certain embodiments, present in an amount of 0.1 to 1 percent by weight, based on the total weight of the coating composition.

In certain embodiments, the coating compositions of the present invention also comprise a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coating compositions of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the coating compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In certain embodiments, special effect compositions can produce a color shift, such that the color of the coating changes when the coating is viewed at different angles. Example color effect compositions are identified in U.S. Pat. No. 6,894,086, which is incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In certain embodiments, a photosensitive composition and/or photochromic composition, which reversibly alters its color when exposed to one or more light sources, can be used in the coating compositions of the present invention. Photochromic and/or photosensitive compositions can be activated by exposure to radiation of a specified wavelength. When the composition becomes excited, the molecular structure is changed and the altered structure exhibits a new color that is different from the original color of the composition. When the exposure to radiation is removed, the photochromic and/or photosensitive composition can return to a state of rest, in which the original color of the composition returns. In certain embodiments, the photochromic and/or photosensitive composition can be colorless in a non-excited state and exhibit a color in an excited state. Full color-change can appear within milliseconds to several minutes, such as from 20 seconds to 60 seconds. Example photochromic and/or photosensitive compositions include photochromic dyes.

In certain embodiments, the photosensitive composition and/or photochromic composition can be associated with and/or at least partially bound to, such as by covalent bonding, a polymer and/or polymeric materials of a polymerizable component. In contrast to some coatings in which the photosensitive composition may migrate out of the coating and crystallize into the substrate, the photosensitive composition and/or photochromic composition associated with and/or at least partially bound to a polymer and/or polymerizable component in accordance with certain embodiments of the present invention, have minimal migration out of the coating. Example photosensitive compositions and/or photochromic compositions and methods for making them are identified in United States Published Patent Application No. 2006-0014099 A1, which is incorporated herein by reference.

In general, the colorant can be present in the coating composition in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions.

The coating compositions of the present invention can, if desired, be formulated with a variety of organic solvents, such as ketones, including methyl ethyl ketone, hydrocarbons, such as toluene and xylene, and mixtures thereof.

In certain embodiments, however, the coating compositions of the present invention are substantially free, or, in some cases, completely free of any solvent, such as an organic solvent or an aqueous solvent, i.e., water. Stated differently, in certain embodiments, the coating compositions of the present invention are substantially 100% active.

The coating compositions of the present invention can be utilized as one package compositions or as two package compositions. As two packs, one package comprises the Michael addition reaction product(s) described above and the second pack comprises the compound(s) having functional groups reactive with the secondary amines of the Michael addition reaction product(s) described above. The previously described additives and other materials can be added to either package as desired or necessary. The two packages are simply mixed together at or near the time of use.

In certain embodiments of the present invention, such as the previously described two package composition, the package comprising the Michael addition reaction product(s) also includes a moisture scavenger. Suitable moisture scavenging ingredients include calcium compounds, such as CaSO₄-½H₂O, metal alkoxides, such as tetraisopropyltitanate, tetra n butyl titanate-silanes, QP-53 14, vinylsilane (A171), and organic alkoxy compounds, such as triethyl orthoformate, trimethyl orthoformate, tetramethyl orthosilicate, and methylorthoformate.

In certain embodiments, the moisture scavenger is present in the package comprising the Michael addition reaction product(s) in an amount of up to 10 percent by weight, such as 0.25 to 9.75 percent by weight, or, in some cases 5 percent by weight, based on the total weight of the Michael addition reaction product(s).

Indeed, the present inventors have surprisingly discovered that the inclusion of a relatively small amount of moisture scavenger to the Michael addition reaction product(s) prevents the Michael addition reaction product(s) from significantly increasing in viscosity over time. As a result, the present invention is also directed to compositions comprising: (1) an ungelled, secondary amine-containing, Michael addition reaction product of reactants comprising: (a) a compound comprising more than one site of ethylenic unsaturation, and (b) an aminofunctional silane, and (2) a moisture scavenger present in an amount sufficient to produce a composition having a viscosity of no more than D after 42 days at 120° F. when measured in accordance with ASTM D1545-89.

Moreover, the present invention is also directed to multi-pack coating compositions, wherein (A) a first pack comprises (1) one or more of the Michael addition reaction products described above; and (2) a moisture scavenger; and (B) a second pack comprises a compound comprising functional groups reactive with the secondary amine groups of (1).

The coating compositions of the present invention are suitable for application to any of a variety of substrates, including human and/or animal substrates, such as keratin, fur, skin, teeth, nails, and the like, as well as plants, trees, seeds, agricultural lands, such as grazing lands, crop lands and the like; turf-covered land areas, e.g., lawns, golf courses, athletic fields, etc., and other land areas, such as forests and the like.

Suitable substrates include cellulosic-containing materials, including paper, paperboard, cardboard, plywood and pressed fiber boards, hardwood, softwood, wood veneer, particleboard, chipboard, oriented strand board, and fiberboard. Such materials may be made entirely of wood, such as pine, oak, maple, mahogany, cherry, and the like. In some cases, however, the materials may comprise wood in combination with another material, such as a resinous material, i.e., wood/resin composites, such as phenolic composites, composites of wood fibers and thermoplastic polymers, and wood composites reinforced with cement, fibers, or plastic cladding.

Suitable metallic substrates include, but are not limited to, foils, sheets, or workpieces constructed of cold rolled steel, stainless steel and steel surface-treated with any of zinc metal, zinc compounds and zinc alloys (including electrogalvanized steel, hot-dipped galvanized steel, GALVANNEAL steel, and steel plated with zinc alloy), copper, magnesium, and alloys thereof, aluminum alloys, zinc-aluminum alloys such as GALFAN, GALVALUME, aluminum plated steel and aluminum alloy plated steel substrates may also be used. Steel substrates (such as cold rolled steel or any of the steel substrates listed above) coated with a weldable, zinc-rich or iron phosphide-rich organic coating are also suitable for use in the process of the present invention. Such weldable coating compositions are disclosed in, for example, U.S. Pat. Nos. 4,157,924 and 4,186,036. Cold rolled steel is also suitable when pretreated with, for example, a solution selected from the group consisting of a metal phosphate solution, an aqueous solution containing at least one Group IIIB or IVB metal, an organophosphate solution, an organophosphonate solution, and combinations thereof. Also, suitable metallic substrates include silver, gold, and alloys thereof.

Examples of suitable silicatic substrates are glass, porcelain and ceramics.

Examples of suitable polymeric substrates are polystyrene, polyamides, polyesters, polyethylene, polypropylene, melamine resins, polyacrylates, polyacrylonitrile, polyurethanes, polycarbonates, polyvinyl chloride, polyvinyl alcohols, polyvinyl acetates, polyvinylpyrrolidones and corresponding copolymers and block copolymers, biodegradable polymers and natural polymers—such as gelatin.

Examples of suitable textile substrates are fibers, yarns, threads, knits, wovens, nonwovens and garments composed of polyester, modified polyester, polyester blend fabrics, nylon, cotton, cotton blend fabrics, jute, flax, hemp and ramie, viscose, wool, silk, polyamide, polyamide blend fabrics, polyacrylonitrile, triacetate, acetate, polycarbonate, polypropylene, polyvinyl chloride, polyester microfibers and glass fiber fabric.

Examples of suitable leather substrates are grain leather (e.g. nappa from sheep, goat or cow and box-leather from calf or cow), suede leather (e.g. velours from sheep, goat or calf and hunting leather), split velours (e.g. from cow or calf skin), buckskin and nubuk leather; further also woolen skins and furs (e.g. fur-bearing suede leather). The leather may have been tanned by any conventional tanning method, in particular vegetable, mineral, synthetic or combined tanned (e.g. chrome tanned, zirconyl tanned, aluminium tanned or semi-chrome tanned). If desired, the leather may also be re-tanned; for re-tanning there may be used any tanning agent conventionally employed for re-tanning, e.g. mineral, vegetable or synthetic tanning agents, e.g., chromium, zirconyl or aluminium derivatives, quebracho, chestnut or mimosa extracts, aromatic syntans, polyurethanes, (co) polymers of (meth)acrylic acid compounds or melamine, dicyanodiamide and/or urea/formaldehyde resins.

Examples of suitable compressible substrates include foam substrates, polymeric bladders filled with liquid, polymeric bladders filled with air and/or gas, and/or polymeric bladders filled with plasma. As used herein the term “foam substrate” means a polymeric or natural material that comprises a open cell foam and/or closed cell foam. As used herein, the term “open cell foam” means that the foam comprises a plurality of interconnected air chambers. As used herein, the term “closed cell foam” means that the foam comprises a series of discrete closed pores. Example foam substrates include polystyrene foams, polymethacrylimide foams, polyvinylchloride foams, polyurethane foams, polypropylene foams, polyethylene foams, and polyolefinic foams. Example polyolefinic foams include polypropylene foams, polyethylene foams and/or ethylene vinyl acetate (EVA) foam. EVA foam can include flat sheets or slabs or molded EVA forms, such as shoe mid soles. Different types of EVA foam can have different types of surface porosity. Molded EVA can comprise a dense surface or “skin”, whereas flat sheets or slabs can exhibit a porous surface

The coating compositions of the present invention can be applied to such substrates by any of a variety of methods including spraying, brushing, dipping, and roll coating, among other methods. In certain embodiments, however, the coating compositions of the present invention are applied by spraying and, accordingly, such compositions often have a viscosity that is suitable for application by spraying at ambient conditions.

After application of the coating composition of the present invention to the substrate, the composition is allowed to coalesce to form a substantially continuous film on the substrate. Typically, the film thickness will be 0.01 to 20 mils (about 0.25 to 508 microns), such as 0.01 to 5 mils (0.25 to 127 microns), or, in some cases, 0.1 to 2 mils (2.54 to 50.8 microns) in thickness.

The coating compositions of the present invention can be cured in a relatively short period of time to provide films that have good early properties which allow for handling of the coated objects without detrimentally affecting the film appearance and which ultimately cure to films which exhibit excellent hardness, solvent resistance and impact resistance. For example, the coating compositions of the present invention can dry in air at low temperatures to a dust free or tack free state in about 30 minutes, in some case 10 minutes or less. Thereafter, they will continue to cure in air at low temperatures so that a completely cured coating is formed in from, for example, 12 hours to 24 hours.

As a result, as previously indicated, the present invention is also directed to methods for coating a substrate. These methods comprise: (A) combining the contents of a first package and a second package, wherein (1) the first package comprises: (a) an ungelled, secondary amine-containing, Michael addition reaction product of reactants comprising, or, in some cases, consisting essentially of: (i) a compound comprising more than one site of ethylenic unsaturation, and (ii) an aminofunctional silane; and (b) a moisture scavenger, (2) the second package comprises a compound comprising functional groups reactive with the secondary amines of the Michael addition reaction product, and (3) the contents of the first package and the second package are combined such that molar ratio of the secondary amines in the Michael addition reaction product to the functional groups reactive with the secondary amines in the resulting combination is 0.7 to 1.3; (B) applying the combination to at least a portion of the substrate; (C) allowing the combination to coalesce form a substantially continuous film; and (D) allowing the combination to completely cure within 24 hours in the presence of air having a relative humidity of 10 to 100 percent and a temperature −10 to 120° C.

Illustrating the invention are the following examples that are not to be considered as limiting the invention to their details. All parts and percentages in the examples, as well as throughout the specification, are by weight unless otherwise indicated.

### EXAMPLE 1

A Michael addition product was prepared as follows from the ingredients listed in Table 1.

TABLE 1

| Ingredient | Parts By Weight |
|---|---|
| Charge 1 | |
| γ-aminopropyltrimethoxysilane¹ | 60.0% |
| Charge 2 | |
| 1,6-hexanediol diacrylate | 40.0% |

¹Silquest A1110 available from Momentive Performance Chemicals.

Charge #1 was added to an appropriate sized, 4-necked flask equipped with a motor driven stainless steel stir blade, water-cooled condenser, and a heating mantle with a thermometer connected through a temperature feedback control device. The contents were stirred under a nitrogen blanket. Charge #2 was added at an appropriate rate to keep the temperature <60° C. Upon completion of Charge #2, the reaction temperature was set to 60° C. The reaction was held at temperature until the disappearance of the acrylate double bond was demonstrated by IR (peak at ˜1621 cm⁻¹) and/or NMR (peaks at ˜5.7-6.4 ppm) analysis.

### EXAMPLE 2

Three different samples were prepared by charging a Michael addition product of Example 1, into a container and mixing in the following ingredients as shown in Table 2 under ambient conditions.

TABLE 2

| Ingredient | Sample 3B | | Sample 3C | | Sample 3D | |
|---|---|---|---|---|---|---|
| Product of Example 1 | 100 | parts | 100 | parts | 100 | parts |
| Triethyl orthoformate² | 5 | parts | 0 | | 0 | |
| Trimethyl orthoformate² | 0 | | 5 | parts | 0 | |
| Tetramethyl orthosilicate² | 0 | | 0 | | 5 | parts |

²Triethyl orthoformate, trimethyl orthoformate and tetramethyl orthosilicate are available from Sigma Aldrich Company.

### EXAMPLE 3

A Michael addition product of Example 1, and Samples “B”, “C” and “D”, of Example 2 were monitored for changes in viscosity via the Bubble Tube Viscosity method in accordance with ASTM D1545-89. The samples were analyzed after 6 weeks at room temperature and 120° F. and results are set forth in Table 3.

TABLE 3

| | Initial | Viscosity after 42 days | Viscosity after 42 days |
|---|---|---|---|
| Sample | viscosity | at 70° F. | at 120° F. |
| Example 1 | A+ | B + sl | E− |
| 3B | A− | A | B+ |
| 3C | A− | A− | B+ |
| 3D | A− | A − sl | B − sl |

### EXAMPLE 4

Coating compositions were prepared by combining the ingredients listed in Table 4 in a suitable container equipped with a paddle blade mixer.

TABLE 4

| Ingredient | Ex. 4A | | Ex. 4B | | Ex. 4C | | Ex. 4D | | Ex. 4F | | Ex. 4H | |
|---|---|---|---|---|---|---|---|---|---|---|---|---|
| Sample 3C | 15 | grams | — | | — | | — | | — | | — | |
| | (0.037 | eq) | | | | | | | | | | |
| Product of | — | | 15 | grams | 15 | grams | 15 | grams | 15 | grams | 15 | grams |
| Example 1 | | | (0.037 | eq) | (0.037 | eq) | (0.037 | eq) | (0.037 | eq) | (0.037 | eq) |
| Eponex | 8 | grams | 8 | grams | — | | — | | 5 | grams | 12 | grams |
| 1510³ | (0.037 | eq) | (0.037 | eq) | | | | | (0.023 | eq) | (0.055 | eq) |
| CN 2262⁴ | — | | — | | 8 | grams | — | | — | | — | |
| BYK 333⁵ | 0.01 | grams | 0.01 | grams | 0.01 | grams | 0.01 | grams | 0.01 | grams | 0.01 | grams |
| DBDTL⁶ | 0.01 | grams | 0.01 | grams | 0.01 | grams | 0.01 | grams | 0.01 | grams | 0.01 | grams |

³Epoxy resin commercially available from Hexion.
⁴Tetrafunctional polyester acrylate resin commercially available from Sartomer.
⁵Polyether modified polydimethylsiloxane surface additive commercially available from Byk-Chemie.
⁶Dibutyltin Dilaurate.

### EXAMPLE 5

The coating compositions of Example 4 were coated onto Bonderite 1000 CRS and chrome treated aluminum panels at film thicknesses of 1, 6 and 14 mils. The coated substrates were allowed to stand under ambient conditions for 24 hours, at which time they were completely cured. The samples were then exposed to various environmental conditions as illustrated in Table 5. The samples were then observed for signs of cracking. Results are set forth in Table 5. In Table 5, the term “No Cracking” means that there was no cracking of the film on the sample and the film was 100% continuous as observed with the naked eye. The term “Moderate Cracking” means that there was some cracking of the film on the sample, but there were other areas of the film on the substrate in which the film was continuous. The term “Severe Cracking” means that there was no section on the panel where cracking did not exist and in some locations the film had lifted off or delaminated.

TABLE 5

| Test | Ex. 4A | Ex. 4B | Ex. 4C | Ex. 4D | Ex. 4F | Ex. 4H |
|---|---|---|---|---|---|---|
| Salt Fog - 300 | No | No | No | Severe | Moderate | No |
| hours (ASTM | cracking | cracking | cracking | Cracking | cracking at | cracking |
| B117) | | | | | 6 and 14 | |
| | | | | | mils | |
| Humidity - 300 | No | No | No | Severe | Moderate | Moderate |
| hours (ASTM | cracking | cracking | cracking | Cracking | cracking at | cracking at |
| D2247) | | | | | 6 and 14 | 6 and 14 |
| | | | | | mils | mils |
| QUV 340 - 300 | No | No | No | Severe | No | No |
| hours (SAE | cracking | cracking | cracking | Cracking | cracking | cracking |
| J2020) | | | | | | |
| GM - APG test | No | No | No | Severe | Severe | Moderate |
| (20 cycles) | cracking | cracking | cracking | Cracking | Cracking | cracking at |
| | | | | | | 6 and 14 |
| | | | | | | mils |
| Cycle B (20 | No | No | No | Severe | Not tested | Not tested |
| cycles) | cracking | cracking | cracking | Cracking | | |
| Heat aging - 300 | No | No | No | Severe | Not tested | Not tested |
| hours at 200° F. | cracking | cracking | cracking | Cracking | | |
| Initial Adhesion | 5B | 5B | 3B | B | 4B | 4B |
| (ASTM D3359)⁷ | | | | | | |

⁷5B represents 100% adhesion with no tape pick off; 1B represents almost no adhesion with >90% tape pick off.

### EXAMPLE 6

A Michael addition product was prepared as follows from the ingredients listed in Table 6.

TABLE 6

| Ingredients | Parts By Weight |
|---|---|
| Charge 1 | |
| γ-aminopropyltrimethoxysilane¹ | 64.2% |
| Charge 2 | |
| Ethyl acrylate | 35.8% |

¹Silquest A1110 available from Momentive Performance Chemicals

Charge #1 was added to an appropriate sized, 4-necked flask equipped with a motor driven stainless steel stir blade, water-cooled condenser, and a heating mantle with a thermometer connected through a temperature feedback control device. The contents were stirred under a nitrogen blanket. Charge #2 was added at an appropriate rate to keep the temperature <60° C. Upon completion of Charge #2, the reaction temperature was set to 60° C. The reaction was held at temperature until the disappearance of the acrylate double bond was demonstrated by IR (peak at ˜1621 cm⁻¹) and/or NMR (peaks at ˜5.7-6.4 ppm) analysis.

### EXAMPLE 7

A Michael addition product was prepared as follows from the ingredients listed in Table 7.

TABLE 7

| Ingredients | Parts By Weight |
|---|---|
| Charge 1 | |
| γ-aminopropyltrimethoxysilane¹ | 42.9% |
| Charge 2 | |
| HIGHLINK ® NanO G 103-31² | 57.1% |

¹Silquest A1110 available from Momentive Performance Chemicals.
²Liquid suspension of colloidial silica nanoparticles in 1.6-hexanediol diacrylate that is commercially available from Clariant Int'l Ltd.

Charge #1 was added to an appropriate sized, 4-necked flask equipped with a motor driven stainless steel stir blade, water-cooled condenser, and a heating mantle with a thermometer connected through a temperature feedback control device. The contents were stirred under a nitrogen blanket. Charge #2 was added at an appropriate rate to keep the temperature <60° C. Upon completion of Charge #2, the reaction temperature was set to 60° C. then gradually increased to 85° C. The reaction was held until the disappearance of the acrylate double bond was demonstrated by IR (peak at ˜1621 cm⁻¹) and/or NMR (peaks at ˜5.7-6.4 ppm) analysis.

### EXAMPLE 8

A pigment dispersion was prepared by mixing component 1, 2, and 3 in Table 8 with a flat mixing blade for pigment grinding. The remaining ingredients were added slowly until the dry pigments were blended in with the resin. Next 2 mm grinding media were added and mixed to a 6.75 Hegman.

TABLE 8

| Component | Description | Amt (grams) |
|---|---|---|
| 1 | Eponex 1510¹ | 985.78 |
| 2 | K-Sperse KD-A504² | 26.92 |
| 3 | EFKA-2720³ | 7.1 |
| 4 | Pigment Yellow 110; Isoindolinone | 98.41 |
| 5 | Yellow Iron Oxide | 68.02 |
| 6 | Pigment Yellow 128; | 213.54 |
| | Benzimidazolone | |
| 7 | Rutile Titanium Dioxide | 600.17 |

¹Epoxy resin commercially available from Hexion.
²Polymeric dispersant commercially available from King Industries.
³Anti-foaming agent commercially available from EFKA Additives.

### EXAMPLE 9

Coating compositions were prepared by combining the ingredients listed in Table 9 in a suitable container equipped with a paddle blade mixer. The coating compositions were coated onto cooled rolled steel at a film thickness of 2-5 mils by spray application at 74 F and 53% relative humidity. Tack free time was measured by lightly touching the coating with a Q-tip until no mark or cotton fibers were left behind.

TABLE 9

| | Example | | |
|---|---|---|---|
| Component/Measurement | 9A | Example 9B | Example 9C |
| Silres ® SY 231¹ | 34.8 g | 34.8 g | 34.8 g |
| Dibutyl tin dilaurate | 0.7 g | 0.7 g | 0.7 g |
| Product prepared as described in | 39.7 g | — | 40 g |
| Example 1 | | | |
| Product prepared as described in | — | 93.8 g | — |
| Example 7 | | | |
| Product prepared as described in | 19.4 g | 16.9 g | 19.5 g |
| Example 6 | | | |
| Eponex 1510² | 5.9 g | — | — |
| HIGHLINK ® NanO G 103-31³ | — | — | 10.7 g |
| Product prepared as described in | 70.0 g | 72.4 g | 70.4 g |
| Example 8 | | | |
| Paint Appearance | smooth, | smooth, | grainy, not |
| | sprayable | sprayable | sprayable |
| Tack Free Time (minutes) | 16 | 7 | N/A |

¹Methoxyfunctional silicone commercially available from Wacker Silicones.
²Epoxy Resin commercially available from Hexion.
³Liquid suspension of colloidial silica nanoparticles in 1.6-hexanediol diacrylate that is commercially available from Clariant Int'l Ltd.

### EXAMPLE 10

Coating compositions were prepared by combining the ingredients listed in Table 10 in a suitable container equipped with a paddle blade mixer. The coating compositions were coated onto cooled rolled steel at a film thickness of 2-5 mils by spray application at 73 F and 21% relative humidity. The coated substrates were allowed to stand at about 80° F. and 40% relative humidity for 1 week, at which time they were completely cured.

TABLE 10

| | Example | Example |
|---|---|---|
| Component/Measurement | 10A | 10B |
| Silres ® SY 231¹ | 34.8 | 37.6 |
| Dibutyl tin dilaurate | 0.7 | 0.7 |
| Product prepared as described in Example 1 | 39.9 | — |
| Product prepared as described in Example 6 | 19.4 | 19.4 |
| N-aminoethyl aminopropyl trimethoxy | — | 17 |
| silane² | | |
| Eponex 1510³ | 6.5 | 10.5 |
| 3-glycidoxypropyltrimethoxy silane⁴ | — | 23.5 |
| Product prepared as described in Example 8 | 70.0 | 75.0 |
| Crosshatch adhesion after 1 wk⁵ | 2B-3B | 5B |
| Mandrel bend results⁶ | 20 mm | 13 mm |
| | cracking; | cracking; |
| | paint | NO paint |
| | delamination | delamination |

¹Methoxyfunctional silicone commercially available from Wacker Silicones.
²Available as Silquest A-1120 from Momentive.
³Epoxy resin commercially available from Hexion.
⁴Available as Silquest A-187 from Momentive.
⁵According to ASTM D3359-02.
⁶According to ASTM D522-93a.

### EXAMPLE 11

A Michael addition product was prepared as follows from the ingredients listed in Table 11.

TABLE 11

| Ingredients | Parts By Weight |
|---|---|
| Charge 1 | |
| Aminoethylaminopropylmethyldimethoxysilane¹ | 63.5% |
| Charge 2 | |
| Hexanediol diacrylate | 36.5% |

¹Available from Momentive Performance Materials.

Charge #1 was added to an appropriate sized, 4-necked flask equipped with a motor driven stainless steel stir blade, water-cooled condenser, and a heating mantle with a thermometer connected through a temperature feedback control device. The contents were stirred under a nitrogen blanket. Charge #2 was added at an appropriate rate to keep the temperature <60° C. Upon completion of Charge #2, the reaction temperature was set to 60° C. The reaction was held at temperature until the disappearance of the acrylate double bond was demonstrated by IR (peak at ˜1621 cm⁻¹) and/or NMR (peaks at ˜5.7-6.4 ppm) analysis.

### EXAMPLE 12

Coating compositions were prepared by combining the ingredients listed in Table 12 in a suitable container equipped with a paddle blade mixer. The coating compositions were coated onto cooled rolled steel at a film thickness of 2-5 mils by spray application at 21 C and 56% relative humidity. Tack free time was measured by lightly touching the coating with a Q-tip until no mark or cotton fibers were left behind.

TABLE 12

| Component/ | | | | |
|---|---|---|---|---|
| Measurement | Ex. 12A | Ex. 12B | Ex. 12C | Ex. 12D |
| Silres ® SY 231¹ | 40.6 | 35 | 43 | 40.6 |
| Dibutyl tin dilaurate | 0.8 | 0.7 | 0.7 | 0.8 |
| Product prepared as | 11.9 | 39.8 | | 11.9 |
| described in | | | | |
| Example 1 | | | | |
| Product prepared as | 27.9 | | 39.8 | 27.9 |
| described in | | | | |
| Example 11 | | | | |
| Product prepared as | 19.4 | 19.4 | 19.4 | 19.4 |
| described in | | | | |
| Example 6 | | | | |
| Eponex 1510² | 13.5 | 6.5 | 21.5 | 17 |
| Tyzor AA-105³ | 12.9 | | | — |
| Product prepared as | 88.0 | 70.0 | 86.0 | 81.2 |
| described in | | | | |
| Example 8 | | | | |
| Tack Free Time | 47 | 18 | 140 | 75 |
| (minutes) | | | | |
| Crosshatch adhesion | 3B | 2B | 3B | 3B |
| after 1 wk⁴ | | | | |
| Pencil hardness | H | H | 2H | H |
| after 1 week⁵ | | | | |
| Direct Impact | 70 | 50 | 80 | 70 |
| after 1 week (in lb)⁶ | | | | |
| Reverse impact | 45 | 4 | 70 | — |
| (in lb)⁶ | | | | |
| Mandrel Bend | 3 mm | 28 mm; paint | 4 mm | — |
| results⁷ | cracking; no | delamination | cracking; no | |
| | delamination | | delamination | |
| Full scribe creep | 3.5 | — | — | 4.7 |
| (mm) after 192 hr | | | | |
| B117 salt spray | | | | |
| Full scribe creep | 5.3 | — | — | 7.2 |
| (mm) after 500 hr | | | | |
| B117 salt spray | | | | |
| Full scribe creep | 7.5 | — | — | 9.6 |
| (mm) after 700 hr | | | | |
| B117 salt spray | | | | |

¹Methoxyfunctional silicone commercially available from Wacker Silicones.
²Epoxy resin commercially available from Hexion.
³Available from DuPont.
⁴According to ASTM D3359-02.
⁵According to ASTM D3363-05.
⁶According to ASTM D2794.
⁷According to ASTM D522-93a.

### EXAMPLE 13

Various pigment dispersions were prepared using the components and amounts listed in Table 13 according to the following procedure. Epoxy resin was added to a stainless steel pot of an appropriate size for the total volume of dispersion. Mild agitation was commenced with a cowles blade and air motor of an appropriate size for the container used. Under agitation, the polymeric dispersant and anti-foaming agent were added. After mixing for 10 minutes all pigments were added slowly under strong agitation. After the final pigment was added mixing was continued for thirty minutes. The cowles blade was then removed and replaced with a solid dispersion disk of the same size. The agitation speed of the air motor was returned to the highest speed attainable and 2 mm zircoa beads were added to approximately one and a half times the weight of the mix in the pot. The pot was placed in a water bath and covered. After several hours, the Hegman grind was checked and stopped when a grind of seven was obtained. Any additional additives were then added under reduced agitation. The zicoa beads were filtered out an appropriate sized filter and store.

TABLE 13

| Material | 13A | 13B | 13C | 13D | 13E | 13F |
|---|---|---|---|---|---|---|
| ADEKARESIN | 1000 grams | 1414 grams | 1452 grams | 1162.3 grams | 1162.03 grams | 381.07 grams |
| EP-4080E¹ | | | | | | |
| K-Sperse XD- | 28 grams | 39.2 grams | 40.27 grams | 32.21 grams | 32.21 grams | 11.28 grams |
| A504² | | | | | | |
| EFKA-2720³ | 10 grams | 14 grams | 14.38 grams | 11.51 grams | 11.51 grams | 4.03 grams |
| Novoperm | 73.3 grams | 106.5 grams | 109.42 grams | 87.54 grams | 87.54 grams | 30.66 grams |
| Yellow M2R70⁴ | | | | | | |
| Benzimidazolone | — | 419.8 grams | 431.27 grams | 345.02 grams | 345.02 grams | 120.85 grams |
| Yellow⁵ | | | | | | |
| Mapico Yellow | 288.9 grams | 102.9 grams | 105.69 grams | 84.57 grams | 84.56 grams | 29.92 grams |
| 1050A⁶ | | | | | | |
| Tiona 595⁷ | 566.9 grams | 823.8 grams | 846.27 grams | 677.02 grams | 677.02 grams | 237.13 grams |
| Sunfast Blue | 0.1 grams | 0.2 grams | 0.15 grams | 0.12 grams | 0.12 grams | 0.04 grams |
| 248-3650⁸ | | | | | | |
| Tinuvin 328⁹ | — | — | — | — | — | 20.54 grams |
| Tinuvin 144¹⁰ | — | — | — | — | — | 61.79 grams |

¹Epoxy resin commercially available from Adeka USA.
²Polymeric dispersant commercially available from King Industries.
³Anti-foaming agent commercially available from EFKA Additives.
⁴Pigment commercially available from Clariant.
⁵Pigment commercially available from Dominion Colour.
⁶Pigment commercially available from Rockwood Pigments.
⁷Titanium dioxide pigment commercially available from Millenium Inorganics.
⁸Pigment commercially available from Sun Chemical.
⁹UV absorber commercially available from Ciba Additives.
¹⁰Butylpropanedioate commercially available from Fine Grinding Corp.

### EXAMPLE 14

Various dispersions were prepared using the components and amounts listed in Table 14. The components were charged to a suitable containing and mixed until uniform.

TABLE 14

| Material | 14A | 14B | 14C | 14D | 14E |
|---|---|---|---|---|---|
| ADEKARESIN EP- | 15.1 grams | 14.64 grams | 14.64 grams | 16.47 grams | — |
| 4080E¹ | | | | | |
| Maglite ® a MM-3237² | 65 grams | 40.8 grams | — | — | — |
| Silres ® SY 231³ | 75 grams | 61.4 grams | 61.4 grams | 69.08 grams | 327.87 grams |
| Maglite ® D MM- | — | — | 40.8 grams | — | — |
| 3231⁴ | | | | | |
| Magchem ® 200AD⁵ | — | — | — | 76.5 grams | 227 grams |

¹Epoxy resin commercially available from Adeka USA.
²High purity magnesium oxide (MgO) particles with a mean particle size of 5 micron commercially available from C.P. Hall.
³Methoxyfunctional silicone commercially available from Wacker Silicones.
⁴High surface area magnesium oxide (MgO) particles commercially available from Merck.
⁵High purity magnesium oxide (MgO) particles having a mean particle size of 1.2 microns.

### EXAMPLE 15

Coating compositions were prepared by combining the “A” pack ingredients listed in Table 15 in a suitable container equipped with a paddle blade mixer.

The “B” pack was prepared by stirring the “Adduct 1” in a suitable container with a paddle blade mixer. “Adduct 2” and/or “Adduct 3” was then added. Next, any other ingredients were added and the mixture was allowed to stir for at least 5 minutes.

TABLE 15

| Component | Ex 15A | Ex 15B | Ex 15C | Ex 15D | Ex 15E | Ex 15F |
|---|---|---|---|---|---|---|
| “A” Pack | | | | | | |
| Example 13A | 35.67 grams | 35.67 grams | — | — | — | — |
| Example 13B | — | — | 61.90 grams | 35.10 grams | — | — |
| Example 13C | — | — | — | — | 37.40 grams | 37.40 grams |
| Example 13D | — | — | — | — | — | — |
| Example 13E | — | — | — | — | — | — |
| Example 13F | — | — | — | — | — | — |
| ADEKARESIN | 3.66 grams | 1.29 grams | 6.3 grams | 3.6 grams | — | — |
| EP-4080E¹ | | | | | | |
| Silres ® SY | — | 3.6 grams | 26.6 grams | 15.1 grams | — | — |
| 231² | | | | | | |
| Example 14A | — | 24.34 grams | — | — | — | — |
| Example 14B | — | — | — | — | 30.83 grams | — |
| Example 14C | — | — | — | — | — | 30.83 grams |
| Example 14E | — | — | — | — | — | — |
| Xylene | — | — | — | — | — | — |
| NANOBYK | — | — | — | 19.4 grams | — | — |
| 3650³ | | | | | | |
| “B” Pack | | | | | | |
| Silres ® SY | 15.37 grams | — | — | — | — | — |
| 231² | | | | | | |
| BYK-333⁴ | 0.22 grams | 0.22 grams | 0.4 grams | 0.2 grams | 0.23 grams | 0.23 grams |
| Dibutyl tin | 0.33 grams | 0.33 grams | 0.6 grams | 0.3 grams | 0.34 grams | 0.34 grams |
| dilaurate | | | | | | |
| Tyzor AA-105⁵ | — | — | — | — | — | — |
| Adduct 1⁶ | 20.0 grams | 20.0 grams | 37.9 grams | 21.5 grams | 20.97 grams | 20.97 grams |
| Adduct 2⁷ | 9.76 grams | 9.76 grams | 16.3 grams | 9.2 grams | 10.23 grams | 10.23 grams |
| Adduct 3⁸ | — | — | — | — | — | — |

| Component | Ex 15G | Ex 15H | Ex 15I | Ex 15J | Ex 15K |
|---|---|---|---|---|---|
| “A” Pack | | | | | |
| Example 13A | — | — | — | — | — |
| Example 13B | — | — | — | — | — |
| Example 13C | 41.96 grams | — | — | — | — |
| Example 13D | — | 37.25 grams | — | — | — |
| Example 13E | — | — | 42.09 grams | — | — |
| Example 13F | — | — | — | 46.01 grams | 46.01 grams |
| ADEKARESIN | 4.31 grams | — | 4.01 grams | 3.37 grams | 3.37 grams |
| EP-4080E¹ | | | | | |
| Silres ® SY | — | 0.85 grams | 18.14 grams | 18.14 grams | 5.14 grams |
| 231² | | | | | |
| Example 14A | — | — | — | — | — |
| Example 14B | — | — | — | — | 30.83 grams |
| Example 14C | — | — | — | — | — |
| Example 14E | — | 36.0 grams | — | — | 22.0 grams |
| Xylene | — | — | — | 11.14 grams | 12.73 grams |
| NANOBYK | — | — | — | — | — |
| 3650³ | | | | | |
| “B” Pack | | | | | |
| Silres ® SY | 18.08 grams | — | — | — | — |
| 231² | | | | | |
| BYK 333⁴ | 0.25 grams | 0.5 grams | 0.5 grams | 0.64 grams | 0.64 grams |
| Dibutyl tin | 0.38 grams | 0.34 grams | 0.39 grams | 0.44 grams | 0.44 grams |
| dilaurate | | | | | |
| Tyzor AA-105⁵ | — | — | — | 2.91 grams | 2.91 grams |
| Adduct 1⁶ | 23.53 grams | 21.94 grams | 24.58 grams | 8.13 grams | 8.13 grams |
| Adduct 2⁷ | 11.48 grams | 9.40 grams | 10.54 grams | 6.97 grams | 6.97 grams |
| Adduct 3⁸ | — | — | — | 8.13 grams | 8.13 grams |

¹Epoxy resin commercially available from Adeka USA.
²Methoxyfunctional silicone commercially available from Wacker Silicones.
³Silica nanoparticle dispersion commercially available from Byk USA Inc.
⁴Polyether modified polydimethylsiloxane surface additive commercially available from Byk-Chemie.
⁵Available from DuPont.
⁶A 95/5 w/w mixture of an adduct prepared as described in Example 1 with triethylorthoformate.
⁷A 95/5 w/w mixture of an adduct prepared as described in Example 6 with triethylorthoformate.
⁸A 95/5 w/w mixture of an adduct prepared as described in Example 11 with triethylorthoformate.

When ready to apply the “A” was combined with the “B” pack under agitation and allowed to mix for at least 5 minutes.

The coating compositions were coated onto iron phosphate pretreated and chrome rinsed cold rolled steel panels (B1000 P60 type panels from ACT) at a film thickness of 2-5 mils by spray application. After two weeks, the panels were tested for gloss and corrosion performance. Results are set forth in Table 16.

TABLE 16

| Test | Ex 15A | Ex 15B | Ex 15C | Ex 15D | Ex 15E | Ex 15F |
|---|---|---|---|---|---|---|
| 60° gloss | 85.5 | 83.2 | 89.9 | 83 | 85 | 83 |
| Corrosion | 3 | 6 | 3 | 4 | 5 | 5 |
| Resistance | | | | | | |
| Rating¹ | | | | | | |

| Test | Ex 15G | Ex 15H | Ex 15I | Ex 15J | Ex 15K |
|---|---|---|---|---|---|
| 60° gloss | 88 | 82 | 86 | 79 | 77 |
| Corrosion | 4 | 6 | 5 | 5 | 6 |
| Resistance | | | | | |
| Rating¹ | | | | | |

¹Coated panels were exposed to salt spray for 700 hours according to ASTM B117 salt spray exposure. Corrosion resistance rating was assigned according to ASTM D1654 procedure A. A higher rating means better results.

It will be appreciated by those skilled in the art that changes could be made to the embodiments described above without departing from the broad inventive concept thereof. It is understood, therefore, that this invention is not limited to the particular embodiments disclosed, but it is intended to cover modifications which are within the spirit and scope of the invention, as defined by the appended claims.

We claim:

1. A low temperature, moisture curable coating composition comprising:
(l) at least one of:
(a) an ungelled, secondary amine-containing, Michael addition reaction product of reactants comprising:
(i) a compound comprising more than one site of ethylenic unsaturation, and
(ii) an aminofunctional silane and/or a polyaminosilane, and
(b) a secondary amine-containing, Michael addition reaction product of reactants comprising:
(i) a compound comprising one site of ethylenic unsaturation, and
(ii) an aminofunctional silane and/or a polyaminosilane;
(2) a compound comprising functional groups reactive with the secondary amine of (1)(a) and/or (1)(b); and
(3) chemically modified particles having an average primary particle size of no more than 500 nanometers.

2. The coating composition of claim 1, wherein components (1) and (2) are present in the composition in amounts such that the molar ratio of the secondary amines to the functional groups reactive with the secondary amines is 0.7 to 1.3.

3. The coating composition of claim 1, wherein the aminofunctional silane comprises a compound having the formula: 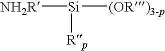
wherein R′ is an alkylene group having from 2 to 10 carbon atoms, R″ is an alkyl, aryl, alkoxy, or aryloxy group having from 1 to 8 carbon atoms, R′″ is an alkyl group having from 1 to 8 carbon atoms, and p has a value of from 0 to 2.

4. The coating composition of claim 3, wherein R′ is an alkylene group having from 2 to 5 carbon atoms and p is 0.

5. The coating composition of claim 3, wherein the aminofunctional silane comprises γ-aminopropyltrimethoxysilane.

6. The coating composition of claim 1, wherein the composition comprises both (1)(a) and (1)(b).

7. The coating composition of claim 1, wherein the compound comprising functional groups reactive with the secondary amines in the Michael addition reaction product comprises a polyepoxide.

8. The coating composition of claim 1, wherein the composition is substantially free of solvent.

9. The coating composition of claim 1, further comprising a polysiloxane.

10. The coating composition of claim 1, wherein the chemically modified particles comprise the reaction product of particles and a compound having a surface active moiety.

11. The coating composition of claim 10, wherein the compound having a surface-active moiety has the general structure F-L-Z wherein F is a moiety containing one or more functional groups that will react with the particle surface, Z is a surface active moiety that decreases the surface tension of the particle, and L is a group that links F and Z.

12. A low temperature, moisture curable coating composition comprising:
(l) at least one of:
(a) an ungelled, secondary amine-containing, Michael addition reaction product of reactants comprising:
(i) a compound comprising more than one site of ethylenic unsaturation, and
(ii) an aminofunctional silane and/or a polyaminosilane, and
(b) a secondary amine-containing, Michael addition reaction product of reactants comprising:
(i) a compound comprising one site of ethylenic unsaturation, and
(ii) an aminofunctional silane and/or a polyaminosilane;
(2) a compound comprising functional groups reactive with the secondary amine of (1)(a) and/or (1)(b); and
(3) inorganic oxide particles comprising one or more of zinc oxide, magnesium oxide, cerium oxide, and molybdenum oxide.

13. The coating composition of claim 12, wherein the composition comprises both (1)(a) and (1)(b).

14. The coating composition of claim 12, wherein the compound comprising functional groups reactive with the secondary amines in the Michael addition reaction product comprises a polyepoxide.

15. The coating composition of claim 12, wherein the composition is substantially free of solvent.

16. The coating composition of claim 12, further comprising a polysiloxane.
